(19) United States
(12) Patent Application Publication
(10) Pub. No.: US 2009/0096308 A1
(43) Pub. Date: Apr. 16, 2009

(54) Rotor For Electric Motor

(76) Inventor: Christian Staudenmann, Mamishaus (CH)

Correspondence Address: NOTARO & MICHALOS P.C., 100 DUTCH HILL ROAD, SUITE 110, ORANGEBURG, NY, 10962-2100, US

(21) Appl. No.: 12/180,429

(22) Filed: Jul. 25, 2008

(30) Foreign Application Priority Data
Oct. 11, 2007 (CH) 01592/07

(51) Int. Cl. H02K 21/12; H02K 15/03

(52) U.S. Cl. 310/156.08; 29/598

(57) ABSTRACT

An electric motor has an internal ferromagnetic rotor ring and an external stator. Circumferentially distributed cutouts in the rotor receive rectangular permanent magnets each having a width b and height h and the rotor ring is divided into rotor poles. The height h forms the longer side of each magnet and is radial to the motor axis. The magnets are magnetized in the width b direction with like poles oriented toward one another. A magnetic clearance is located between adjacent magnets for each inner portion of a rotor pole. The clearance does not contain magnetic material and in a center region of the rotor poles one support web connects an inner support ring with the particular rotor pole to provide mechanical support.

### FIELD AND BACKGROUND OF THE INVENTION

The invention relates to an electric motor and to a method for the production of an electric motor.

Such electric motors are employed wherever high power performance with electronically controllable rotational number is required and with a response behavior with as short a delay as possible. In addition, in such applications often as compact a structuring method as possible is required. In the case of electric motors of this type the magnetic field of the rotor is generated with high-power permanent magnets and the rotating field is generated with externally located stator windings encompassing the rotor, which windings are electronically energized or commutated or regulated. The regulation preferably takes place as a sinusoidal regulation (FOC). The permanent magnets are conventionally slid into a rotor ring of magnetic material and fastened, which ring is comprised of a full laminated core and encompasses the magnets as is shown schematically in FIG. 3 and in cross section. The externally located stator 20 encompasses the internally located rotor 1 with the common central motor axis 2. The rotor 1, disposed on a motor shaft 3, is comprised of a rotor ring of a laminated core, as a rule of iron, with cutouts radially oriented and uniformly circularly distributed for permanent magnets 5. The magnetization direction of the permanent magnets is developed transversely to the radial direction and the poles of the magnets 5 are oriented alternately pairwise toward one another, as is shown by the arrows. Between two permanent magnets each are thereby formed rotor poles 4 within the laminated core ring of the rotor 1. Disadvantages of known motor configurations are that the disposition of the permanent magnets, together with the laminated core arrangements, for the guidance of the magnetic fluxes for the development of the rotor poles have magnetic shunts 13 and leakage fluxes which do not make a contribution to the function of the motor, in particular for the torque formation, and consequently represent a magnetic field loss whereby the full utilization of the magnets and the efficiency of the motor potentially decrease. Such motors require a certain installation space for a certain output capacity.

For applications with high requirements in this regard the known motor implementations are therefore only conditionally suitable.

A very important application field for such motors is their employment in equipment assemblies of motor vehicles. Especially preferred are here in particular motor drives of this type in vehicle steering arrangements due to the requirements which are here especially high. The application in vehicle steering arrangements relates in particular to the drive for electrically assisted steering boosters and/or for steering angle superposition devices or rotational number superposition devices.

In the electrically assisted steering booster a servo force is coupled from an electric motor with succeeding reduction gear, according to the deflection of the steering wheel or according to the torque exerted onto the steering wheel, onto the steering shaft or onto the transverse toothed rack of the steering system. Thereby, the force expenditure at the steering wheel for steering the motor vehicle is decreased. It is also possible to provide the supply of booster force with the aid of electronic control means at the correct point in time and according to the desired behavior, for example also correspondingly more strongly when the vehicle is standing still. Such electrically assisted steering boosters are therefore currently increasingly more frequently applied.

A further important application area of such electric motor—gearing arrangements in steering systems relates in particular to the steering angle superposition device with booster drive for a steering system for track-free motor vehicles which superposes the rotational angle of the booster drive and of the steering interventions at the steering wheel by the driver and transfers them to the steering movement of the wheels.

To the extent they are applied in steering systems, such rotational angle superposition devices are also referred to within prior art as rotational angle superposition devices. Rotational number superposition or rotational angle superposition are synonyms.

A number of systems are known within prior art for the implementation of electric booster drives with gearing arrangement for use in the previously denoted arrangements.

### SUMMARY OF THE INVENTION

The present invention addresses the problem of eliminating at least some of the disadvantages of prior art. In particular, a compact electric motor with increased efficiency at lower manufacturing cost is to be realized. The electric motor drive is to be especially suitable for the use in motor vehicle steering arrangements such as, in particular, for steering boosters and/or rotational number superposition devices.

The problem is solved according to the invention through the implementation of an electric motor according to the claims and by proceeding according to a method for the production of an electric motor. The dependent patent claims relate to preferred embodiments of the electric motor and to a preferred motor vehicle steering mechanism with such a motor.

The electric motor comprises herein an internally disposed rotor with rotor poles, permanent magnets and an externally disposed stator with stator poles and stator windings disposed thereon. The rotor and the stator encompass the same centrally located motor axis. The stator consequently encompasses the inner rotor supported rotatably about the motor axis. Viewed in cross section, the rotor is implemented as a rotor ring of ferromagnetic material with several cutouts for magnets formed thereon, which magnets are distributed circularly and spaced apart and in which permanent magnets are disposed, whereby the rotor ring is divided into rotor poles, each located between two permanent magnets. The permanent magnets are rectangular in cross section with width b and height h. Height h is herein the longer side (preferably more than twice as long as width b) and is oriented in the radial direction away from the motor axis. The permanent magnets are magnetized in the direction of their width b and disposed such in the rotor ring that the formed magnetic poles N and S of two adjacent permanent magnets are oriented with like poles toward one another, and thus repellently. For each inner portion of a rotor pole located between two adjacent permanent magnets and oriented toward the motor axis, in the associated end region of the permanent magnets a magnetic clearance is formed, thus one clearance on both sides of an inner end region of each permanent magnet. This magnetic clearance, consequently, does not contain any magnetic material. In the particular central region of the rotor poles for each rotor pole a support web is formed in the radial direction, which web connects an inner support ring with the particular rotor pole such that it provides mechanical support. This support web is delimited in the circumferential direction on both sides by the magnetic clearances.

The magnetic fluxes in the inner region directed toward the motor axis of the rotor are thereby conducted such that fewer non-usable shunts are provided and thereby the usable magnetic circuit is facilitated whereby the attainable torque is increased. The magnetic energy generated through the permanent magnets is therewith better utilized. The path of the leakage fluxes is implemented to be as long as possible and with a magnetic resistance as large as possible and simultaneously, through the remaining support webs which connect the poles and the inner support ring, the rotor arrangement is held together under mechanical definition.

By magnetic clearance in the rotor is to be understood a region of the rotor which is magnetically passive. In the simplest case this region is formed by a hollow space, which fills with air or is filled with a nonmagnetic material, such as a synthetic resin or a filling of aluminum, in the rotor which is formed of one or several magnetic materials.

In a further development of the invention, due to its special suitability, the electric motor introduced here is preferably applied for drives in motor vehicle steering arrangements, in particular as a drive for electrically assisted steering boosters and/or for rotational number superposition devices. Such devices can thereby be realized especially compactly and economically and can meet the requirements which here are high, such as high reliability, good drivability or controllability and fast response.

The application here takes place, especially preferred, in a motor vehicle steering mechanism in which the rotational number of the rotor of the electric motor is coupled into the steering system by means of a disk cam gearing or a harmonic drive gearing.

In the case of the preferred application of a disk cam gearing, the system comprises a drive connected via a disk cam gearing with an output shaft with the motor axis with a steering gearing, wherein the disk cam shaft comprises:

at least one disk cam with wave-like outer contour disposed eccentrically rotatably about the motor axis,

the at least one disk cam has a circular central opening in the center,

the at least one disk cam has at least two bores which are located on a concentric reference circle between the central opening and the outer contour,

a first carrier disposed on a first shaft whose axis is in the motor axis, wherein on the first carrier in the direction parallel to the motor axis, actuator bolts 57 are disposed which engage into the bores of the disk cam,

a rotor shaft as a connection gearing coaxially disposed, and supported rotatably about the first shaft with the common motor axis and this shaft is connected with the rotor, proposed in the invention, of the electric motor and bears at least one eccentric with an eccentricity with respect to the motor axis, wherein each eccentric engages into the central opening of an associated disk cam for the generation of a laterally gyratory movement, rotating about the motor axis, of the particular disk cam,

a second carrier disposed on a second shaft, which is formed as an output shaft and whose axis is in the motor axis and which shaft is rotatable about this axis, wherein on the second carrier in the direction parallel to the motor axis outer bolts, radially spaced apart, are disposed, on which rolls out the wave-form outer contour of the at least one disk cam through the eccentric radially gyratory movement.

This disk cam gearing can be utilized as a reduction gearing for use in an electrically assisted steering booster for coupling a servo force into the steering arrangement depending on the steering wheel deflection or on the generated control signal through the intention of the driver. In this embodiment the first shaft, on which the first carrier is disposed, is fixed on the carrier arrangement and forms a holding shaft such that it cannot rotate.

In the implementation of the driving arrangement as a rotational number superposition mechanism in a motor vehicle steering arrangement the first shaft on which is disposed the first carrier, is disposed such that it is bearing supported rotatably about the motor axis and connected with the steering wheel. The first carrier in this embodiment is correspondingly rotatable about the motor axis. This first shaft is formed as an input shaft which is directly or indirectly connected with the steering wheel for the transmission of rotational movements. Upon the rotation of the steering wheel about a certain angle, this input shaft is correspondingly rotated on the disk cam gearing and the output shaft is rotated about a desired angle whose magnitude depends on the superposed rotational number of the electric motor. Analogously takes place a rotational number or rotational angle superposition between the input shaft and the rotor, on the one hand, and the output shaft, on the other hand.

Disk cam gearings can be formed with one or more disks. Apart from the implementation of secondary form elements for other functions, such as lubrication, etc., the disks are herein preferably identical. They have the same wave-like outer contours and the same number, disposition and dimension of the bores. The central bore for the eccentric guidance in the center of the disk is identical in terms of diameter and disposed coaxially with the disk. For each disk a separate eccentric is provided on the rotor of the drive. Consequently, each disk is moved by an associated eccentric about the same lateral eccentricity, however, with different phase position or angular position in the direction of rotation. When using two disk cams, two eccentrics are utilized, which are disposed on the rotor such that they are offset by an angle of approximately 180°. When using three disk cams, three eccentrics are utilized which are disposed on the rotor offset by an angle of approximately 120°.

The angle is frequently not placed at 180°, 120° or the value of 360° divided by the number of disk cams, so that additional prestresses and/or stress releases within the gearing are attained. Values of up to +/−3° represent conventional values for the discrepancy from the particular nominal value and are accordingly referred as “approximately”.

The structure with two disk cams and two eccentrics can be realized especially advantageously and is preferred since the structure is simple and entails good uniform running properties at low running noise.

The outer bolts, on which roll out the wave-form outer contours of the disk cams, are preferably circular and are further, to decrease the friction, preferably supported rotatably about their own axis, for example through a friction or needle bearing.

It is, however, conceivable and feasible to replace the outer bolts with an outer circumferential contour which models the surface regions of the outer bolts on which the wave-form outer contour of the disk cam is in contact with the outer bolts in the case of the embodiment with the outer bolts. The remaining surface regions should optionally be implemented such that, during the entire revolution of the disk cams, they do not come into contact with the wave-form outer contour of the disk curves. This alternative embodiment is advantageously employed to increase the stiffnesses, in particular at high torques to be transferred.

Alternatively to the application of a disk cam gearing, it is conceivable and feasible to combine the electric motor according to the invention in a rotational number superposition device based on a harmonic drive gearing, such as is introduced in WO 2006/039825.

In this rotational number superposition device an input shaft and an output shaft are oriented toward one another in the axial direction and are supported rotationally movable in a housing and are rotatable independently of one another. The input shaft is operationally connected with a steering wheel in a steering system. The housing is disposed stationarily on the chassis on the motor vehicle and does not rotate with the input nor with the output shaft. Coaxially about the input shaft is disposed a rotor supported with bearings rotatably with respect to the housing, which rotor is driven by the stationarily disposed encompassing stator, the stator and the rotor being implemented according to the invention and consequently form the electric motor according to the invention. On the rotor is disposed as a connection-gearing member a wave generator which, for example, is comprised of an oval disk on the circumference of which directly or indirectly a flexible ring with outer toothing is supported and which forms a connection gearing element. This outer toothing engages into an inner toothed wheel at least at two opposite circumferential points. This inner toothed wheel is connected torsion-tight with the output shaft, the input shaft being connected torsion-tight with the outer-toothed flexible ring.

The use of a disk cam gearing, also referred to as a cycloid gear, or of a harmonic drive gearing is especially suitable since it has low running noise and can be produced as an especially compact assembly in a motor vehicle steering arrangement with electric motor drive.

The disk cam gearing or the harmonic drive gearing permits the coaxial disposition and the simple integration with an electric motor, preferably an electric motor implemented corresponding to the present invention. The application of the electric motor according to the invention in combination with a disk cam gearing or a harmonic drive gearing for steering systems is especially advantageous since these combinations, compared to the combination of a superposition gearing based on a different gearing, for example a planet gearing, with the electric motor according to the invention permits an especially compact and light-weight assembly with low moments of inertia.

The implementation according to the invention of the rotor of the electric motor in combination with the disk cam gearing or the harmonic drive gearing permits the connection of the rotor with the connection gearing member via the magnetic clearances in the rotor. For example, the connection gearing member can have corresponding nonmagnetic form-closure elements, which engage into the magnetic clearances in the rotor. Both elements can preferably also be connected with one another via a synthetic resin by filling out corresponding hollow spaces.

The implementation according to the invention of the rotor of the electric motor permits significantly improved magnetic fluxes in operation and yet high strength such that the connection gearing member of the reduction gearing can be especially advantageously integrated. The improved flux properties also simplify the measuring of the rotation position of the rotor of the electric motor since fewer magnetic leakages form such that the signal-to-noise ratio is improved in the event electrical or magnetic measuring methods are utilized.

In an advantageous further development of the invention into the superposition gearing a safety coupling or a gearbox is integrated, which, in the event of failure or special vehicle situations—such as for example power failure, failure of the steering or switched off ignition, etc.—forces the direct mechanical coupling between input and output shaft, such that the driver obtains complete control over the steering system. In a highly simple manner the coupling can take place, for example, through the blocking of the rotor of the booster drive with respect to the stator, or to the housing of the device.

According to the introduced invention, the disposition of the superposition device and/or of the steering booster is possible with the electric motor between steering gearing and steering wheel as well as also between steering gearing and tie rod or in the steering gearing. The selection is carried out according to the particular structural conditions of the installation space and according to other technical and commercial requirements. For the case that the device is disposed between steering gearing and tie rod or in the steering gearing, as a rule, the output shaft is directly connected with a conversion gearing for the speed transformation of a rotational movement into a translational movement. For example, here a ball screw nut is driven directly.

The various features of novelty which characterize the invention are pointed out with particularity in the claims annexed to and forming a part of this disclosure and are entirely based on the priority application, Swiss Patent Application No. 01592/07 filed Oct. 11, 2007.

### BRIEF DESCRIPTION OF THE DRAWINGS

In the following the invention will be explained in further detail by example and with schematic figures for preferred embodiments. The drawing depict:

FIG. 1 a cross section of an electric motor through rotor and stator according to the invention,

FIG. 2 in cross section an electric motor corresponding to FIG. 1 with plotted field line course of the magnetic field in operation,

FIG. 3 in cross section an electric motor according to prior art with plotted field line course of the magnetic field in operation,

FIG. 4 a schematic structure of a steering system with booster power assistance and/or rotational number superposition device,

FIG. 5a in three-dimensional representation and in section embodiment of a rotational number superposition device with a disk cam gearing with two disk cams, combined with an integrated electric motor according to the invention, all disposed coaxially,

FIG. 5b detail enlargement of a segment of the view of FIG. 5a,

FIG. 6 a cross section through the disk cam gearing of the arrangement according to FIG. 5a with two disk cams disposed one behind the other,

FIG. 7 a detail view of the output shaft with the carrier for the outer bolts,

FIG. 8 a detail view of the input shaft with the carrier for the actuator bolts,

FIG. 9 three-dimensional representation of a first disk cam in detail,

FIG. 10 three-dimensional representation of a second (identical) disk cam in detail seen from the other side compared to the view in FIG. 9,

FIG. 11 a rotor shaft with two eccentrics disposed thereon offset by 180°,

FIG. 12 detail enlargement of a segment in the region of a magnet of the view of FIG. 1, and

FIG. 13 detail enlargement of a segment of the view of FIG. 1 corresponding to FIG. 12, the permanent magnets being cut out.

### DESCRIPTION OF THE PREFERRED EMBODIMENT

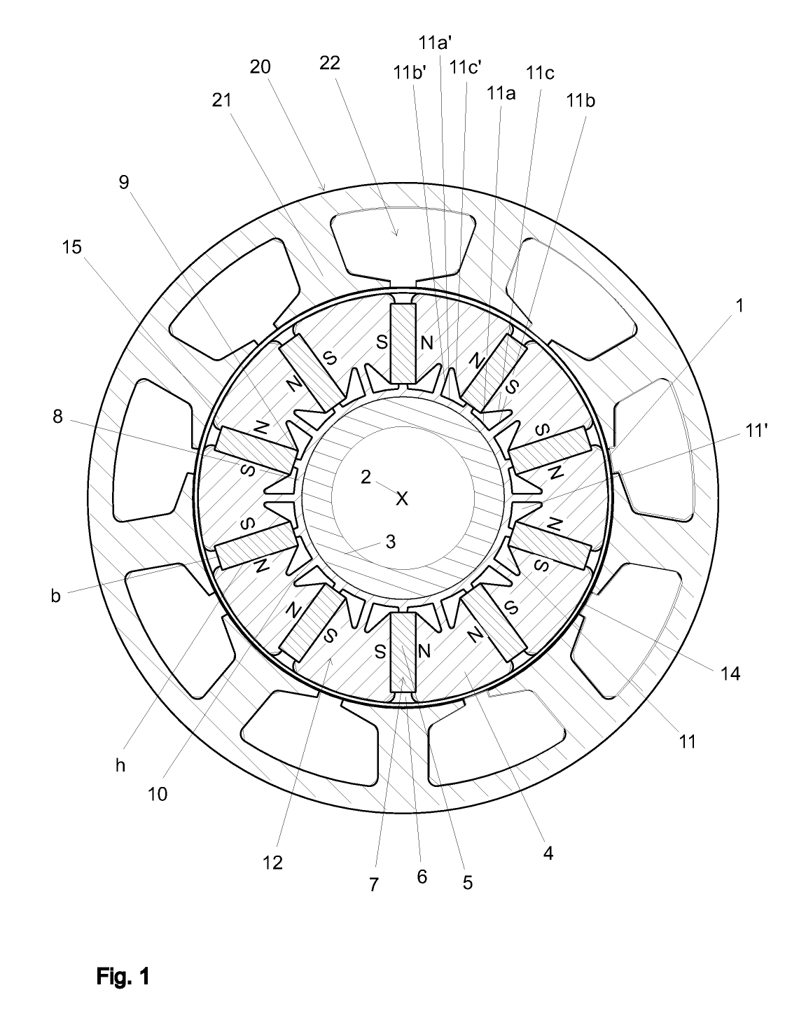

An electric motor according to the invention with magnetic flux under optimized guidance in the rotor is depicted in cross section in FIGS. 1, 2, 12 and 13. The electric motor contains a rotor 1, which is supported rotatably about the central motor axis 2 with a motor shaft 3 and a stator 20 encompassing the rotor 1. The stator 20 includes stator poles 21 of a magnetic material, which are directed toward the rotor 1, which comprises rotor poles 4 of a magnetic material and is spaced apart from it across a small air gap 14, such that the rotor 1 is not in contact with the stator 20 and can freely rotate. Each of the stator poles 21 carries a stator winding 22 for generating a rotary field This rotary field is preferably generated with electronic means and can, according to the desired operating conditions, be controlled and regulated in different ways, such as for example frequency and power.

The rotor poles 4 of magnetic material are disposed in a rotor ring 12 about the motor axis 2. This rotor ring 12 includes cutouts 7 for magnets, which cutouts 7 receive permanent magnets 5, which, spaced apart from one another, are disposed annularly whereby the rotor ring 12 is divided such that between two adjacent permanent magnets 5 rotor poles 4 of magnetic material are formed. The permanent magnets 5 are preferably disposed such that they are uniformly distributed in the form of a ring about the motor axis 2. For special purposes, such as for example for the compensation of irregularities in the running-true of a rotor 1, for example of interference effects such as ripples, the permanent magnets 5 can also be slightly offset compared to a uniform distribution.

The permanent magnets 5 have an elongated shape and in cross section are preferably substantially rectangular with width b and length, or height, h. Utilized are high-power magnets, preferably magnets comprising neodymium, such as of type neodymium-iron-boron magnets, which can also be slightly rounded off at the edges and corners. The permanent magnets 5 are oriented in the rotor 1 such that the longer side of the magnets 5, thus the height h, is positioned in the radial direction away from the motor axis 2 and the shorter side, the width b, is oriented in ring-form direction on the rotor 1. The height h of the permanent magnets 5 is formed to be as long as possible with respect to the width of the rotor ring 12, which rotor ring is divided by these into the rotor poles 4. The permanent magnets 5 are magnetized over their width b such that on both sides on their surface along their height there are magnetic poles, on one side a north pole N and on the other side a south pole S. The permanent magnets 5 are formed in the shape of plates which expand in the axial or parallel direction to the motor axis. Within the rotor the permanent magnets are oriented with like poles toward one another such that in the rotor poles 4 disposed in between them an intensification of the magnetic field develops and at the outer circumference of the rotor 1 the rotor poles have a magnetic field with alternating polarity which subsequently are in engagement with the rotary magnetic field of stator 20. The number of permanent magnets 5 and of the formed poles 4 is an even number, wherein the number of the stator poles 21 with the stator windings 22 is one less. A highly advantageous arrangement includes ten rotor poles 4 and nine stator poles 21.

The permanent magnets 5 are held radially and laterally 12 within the cutouts 7 by the rotor ring. At the outer circumference as well as also at the inner circumference of the rotor ring 12 therefore means for the mechanical or form-fit mounting must be provided such that, even at the high rotational numbers to be attained, the strength and the coherence of the rotor is ensured. In addition, or alternatively, the permanent magnets 5 can be secured in place on the rotor 1, for example by adhesion, be cemented or by soldering or also sinter-bonding. The height h is slightly shorter than the width of the rotor ring 12. For the purpose of a form-fit mounting, on the outer circumference of rotor 1 are provided small holding noses 15 which only slightly project beyond the edge at the width b of the permanent magnets, such that at the width b here as wide as possible an air gap 6 remains between the adjacent rotor poles 4 in order to avoid in this region undesirable shunts and, thus, losses of the magnetic field.

In the inner region of rotor ring 12, directed toward the motor axis 2, a thin support ring 8 is disposed on rotor ring 12, which mechanically holds the rotor 1 together. In the inner region, at the ends of permanent magnets 5 on both sides are provided symmetrically disposed magnetic clearances 11, 11′, and in the region of the middle of each rotor pole 4 a thin support web 10 is formed which extends in the radial direction to the motor axis outwardly and mechanically connects the inner support ring 8 with the material of poles 4. The support web is formed as thin as possible, however such that the mechanical forces occurring in the rotational number range of the motor can be absorbed and the rotor 1 is reliably held together. The magnetic clearances 11, 11′ effect an extension of the path within the magnetic material in the interior region of the rotor ring 12, whereby the magnetic shunts 13, 13′ can be decreased for the purpose of increasing the efficiency. The magnetic clearances 11, 11′ do not contain any magnetic material and, in the simplest case, form a type of hollow space or air gap. However, for better consolidation of the rotor arrangement these hollow spaces can also be filled with nonmagnetic materials, such as nonmagnetic metals, PM materials or synthetic materials, preferably cast resin. In the interior region at the end side, in the proximity of its width b the permanent magnet 5 is connected with the support ring 8 via a web-like magnet staying 9 and is thereby fixed. Rotor 1 with the support ring 8 can be pulled over a motor shaft 3 or the support ring 8 itself can also simultaneously be formed partially or entirely as the motor shaft 3.

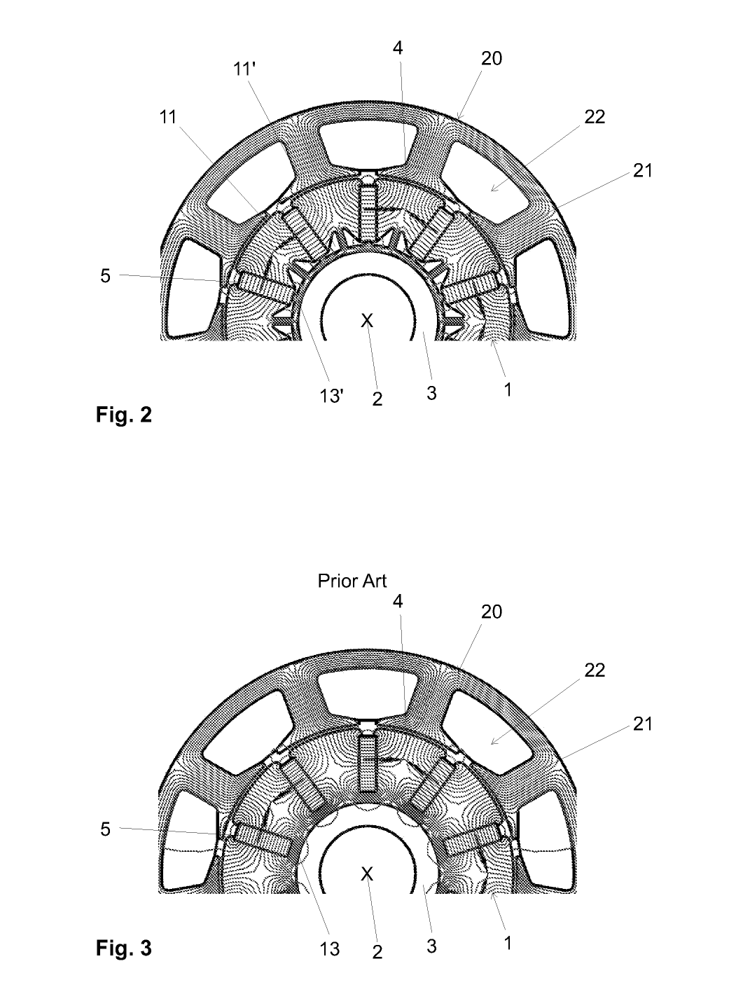

Through the implementation according to the invention of rotor 1, in particular through the implementation of magnetic clearances 11, 11′ in the inner region of the rotor 1, magnetic shunts 13′ can be drastically decreased in the proximity of the inner end faces of the permanent magnets 5 and the rotor 1 can, nevertheless, be reliably held together mechanically, as is depicted in the FIG. 2 through the course of the magnetic fields. In FIG. 3 an arrrangement according to prior art with the contour of the magnetic fields is shown and it is evident that in the inner region a strong shunt 13 at the end side over the width b of the permanent magnets 5 is formed, which lowers the power capacity of the electric motor.

The electric motor according to the invention thus comprises an inner rotor 1 with rotor poles 4 and with permanent magnets 5 and with an outer stator 20 with stator poles 21 and stator windings 22 disposed thereon, with the rotor 1 and the stator 20 encompassing the same centrally located motor axis 2 and the rotor 1 in cross section being formed of a ferromagnetic material with several cutouts 7 disposed thereon for magnets 5, which are disposed circularly distributed and spaced apart, and in which permanent magnets 5 are disposed whereby the rotor ring 12 is divided into rotor poles 4, each located between two permanent magnets 5, wherein the permanent magnets 5 are formed rectangularly in cross section with width b and height h and height h forming the longer side oriented in the radial direction away from the motor axis 2, and the permanent magnets 5 are magnetized in the direction of their width b and are so disposed in the rotor ring 12 that the formed magnet poles N, S of two adjacent permanent magnets 5 are oriented with like poles toward one another, wherein for every inner portion of a rotor pole located between two adjacent permanent magnets 5 of the end region directed toward the motor axis 2 of the permanent magnets 5 in each instance a magnetic clearance 11, 11′ is formed, and this clearance does not contain any magnetic material such that in the particular central region of the rotor poles 4 in the radial direction for each rotor pole 4 a support web 10 is formed which connects an inner support ring 8 with the particular rotor pole 4 providing mechanical support.

The support web 10 should not be too wide and short as little as possible of the magnetic flux in the region of the inner ends directed toward the motor axis 2. It is advantageous if the support web 10 has a width in the range of 5% up to maximally 50% of the spacing of the inner ends of two adjacent permanent magnets 5. In the radial direction outwardly the magnetic clearance 11, 11′ should as much as possible be expanded, preferably up to maximally in the center of height h of the permanent magnet. It should have an expansion in the radial direction of at least 10% and maximally 50% of height h of the permanent magnet 5.

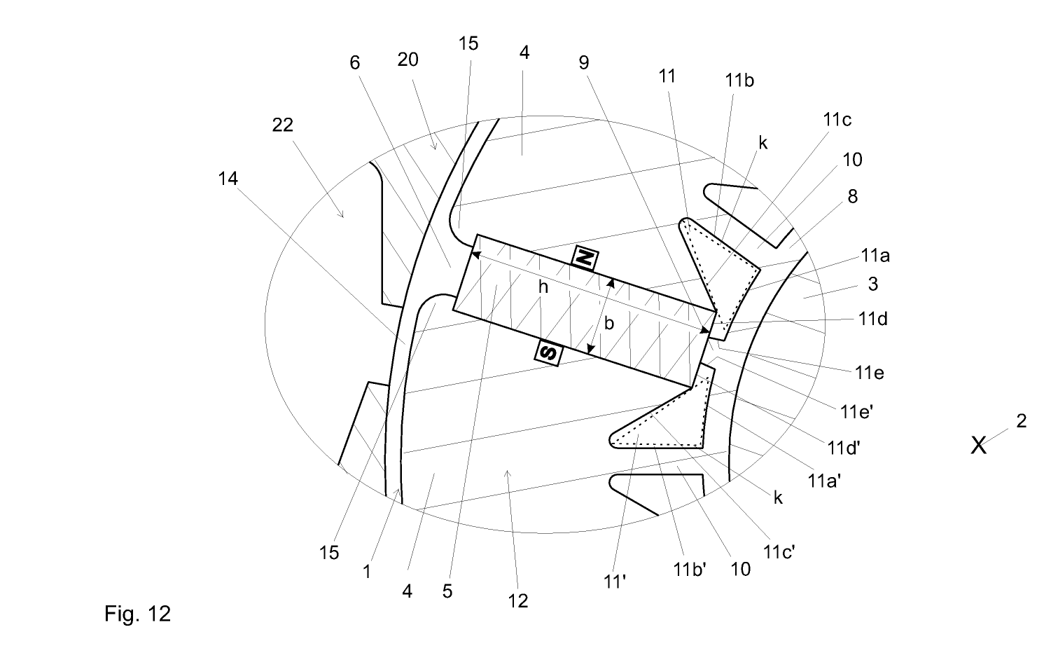

The cross section of the magnetic clearances 11, 11′ is advantageously formed substantially in triangular form. A first side 11a, 11a′ of the triangle extends in the circumferential direction on the side of the permanent magnet 5 oriented toward the motor axis 2, approximately parallel to the magnet width b and approximately perpendicularly to the magnet height h, and is delimited radially toward the inside by the support ring 8. A second side 11b, 11b′ of the triangle extends in the radial direction, approximately parallel to the orientation of the magnet height h, and approximately perpendicularly to the orientation of the magnet width b, and on the side of the clearance 11, 11′ facing away from the permanent magnet 5, and is accordingly delimited by support web 10. The first side 11a, 11a′ and the second side 11b, 11b′ are disposed approximately perpendicularly with respect to one another and are in contact on the side, facing away from the permanent magnets 5 and facing the motor axis 2, of the magnetic clearance 11, 11′. The third side of triangle 11c, 11c′ extends on the side directed toward the motor axis 2, of the permanent magnet 5 to the end, directed away from the motor axis, of the second side 11b, 11b′. The first side 11a, 11a′ is preferably not planar but rather shaped in the form of an arc along the circumferential direction. In FIG. 12 the shape of the clearance is illustrated by a dashed line k.

In a preferred embodiment the third side 11c, 11c′ is preferably formed in the approximate shape of a concave arc which forms a releasing clearance for the side, oriented radially to the motor axis 2, of the permanent magnet 5.

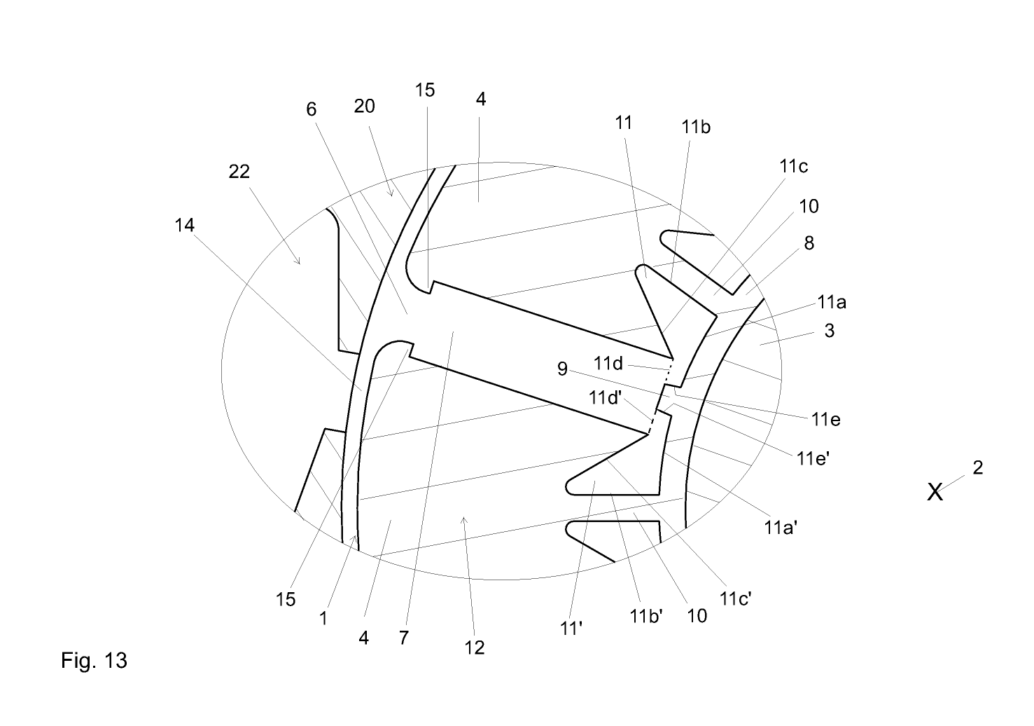

In a further preferred embodiment the clearances are formed by a pentagonal cross sectional shape. The first side 11a, 11a′ and the second side 11b, 11b′ extend analogously to said embodiment examples. The fifth side 11e, 11e′ extends from the end, facing the permanent magnets 5, of the first side 11a, 11a′ in the radial direction toward the permanent magnet and is delimited by the magnet staying 9. Thereon adjoins at approximately right angles the fourth side 11d, 11d′, which extends correspondingly approximately in the circumferential direction and is delimited by the permanent magnet 5, as is illustrated in FIG. 13 by the dashed line. This means that the cutout 7 for the permanent magnet 5 over this fourth side 11d, 11d′ borders the magnetic cutout. The fourth side 11d, 11d′ extends in the circumferential direction from the magnet staying 9 to the outer end of the permanent magnet 5. Its length is advantageously in the range of the 0.37-fold up to one fourth of the width b of the permanent magnet 5. Directly at the end of the fourth side 11d, 11d′ adjoins the third side 11c, 11c′, which extends toward the end, directed away from the motor axis 2, of the second side 11b, 11b′. Further, the lengths (or arc lengths) of the first, second and third sides advantageously differ from one another by less than 30%.

In this embodiment three of the five corners, namely the corners in which abut the third and the fourth side, the fourth and the fifth side as well as the first and the fifth side, are located in a radius which is smaller than the radius in which all corners of the pentagon are located, and is preferably smaller than the third portion of the radius in which all corners of the pentagon are located.

Within the scope of the invention this pentagonal cross sectional form of the magnetic clearance is encompassed by the term “substantially triangular” which is illustrated by the dashed line k in FIG. 12.

It is evident that in all embodiments all corners which are formed by the junction of the sides of the clearance can be rounded off.

Due to the previously denoted implementation of the rotor 1 it is possible to implement the rotor ring 12 with the rotor poles 4, the support webs 10, the support ring 8 with the cutouts 7 for the magnets 5 and the magnetic clearances 11, 11′ without magnetic material in cross section as a single coherent part of magnetic material. The required mechanical strength is ensured and simultaneously very good magnetic field contours can be attained. The divided rotor ring 12 can be cut in simple and economical manner of sheet metal parts, preferably punched and be stacked to form a rotor 1, wherein all elements contiguously connected in cross section can be punched out of a single metal sheet. The parts are preferably fabricated of iron sheet metal wherein in this case several such iron metal sheets are stacked in the axial direction to the motor axis to form a rotor 1.

The support web 10 with the magnetic clearances 11, 11′ formed on both sides thereon is geometrically formed such that the magnetic material of the support web 10 is saturated by the generated field of the permanent magnets 5.

It is especially economical if the stator poles 21 and the rotor poles 4 with their implementations, the cutouts 7 and clearances 11, 11′, are jointly cut from one metal sheet, preferably are punched out of iron sheet metal, and several are layered to form one stator pack and one rotor pack each, wherein one stator sheet and one rotor sheet are in each instance simultaneously punched out of a single piece of sheet metal.

The electric motor is preferably employed in booster drives in steering mechanisms for motor vehicles. Such a booster drive can herein be utilized in an electrically assisted steering booster for the steering force support or rotational moment support and/or a rotational number superposition device. Thereby extremely compact structuring methods are made possible while meeting the safety and operation requirements which in this area are high.

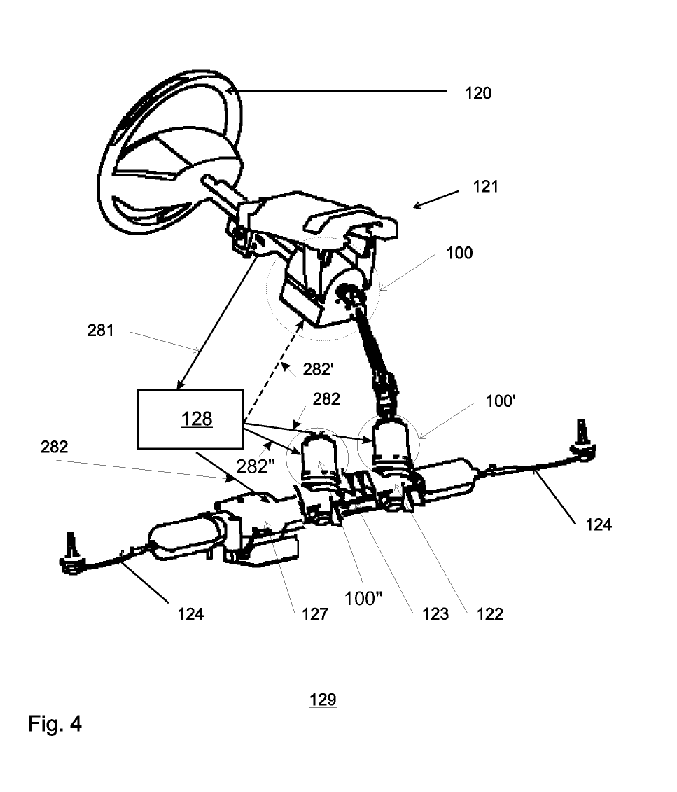

The schematic structure shown in FIG. 4 of a steering mechanism 129 with electric booster assistance corresponds substantially to prior art. It is inter alia comprised of a steering wheel 120, a steering column 121, the steering gearing 122 and the two tie rods 124. The tie rods 124 are driven by the toothed rack 123. For the rotational number superposition serves the superposition device 100, 100′ or 127. The superposition device 100′ can also be integrated directly into the steering gearing 122. The device can be somewhat modified, and can also be implemented as booster drive 100″ for an electrically assisted steering booster, which also can be disposed in the proximity of the steering gearing or of the steering column for coupling in a steering booster force.

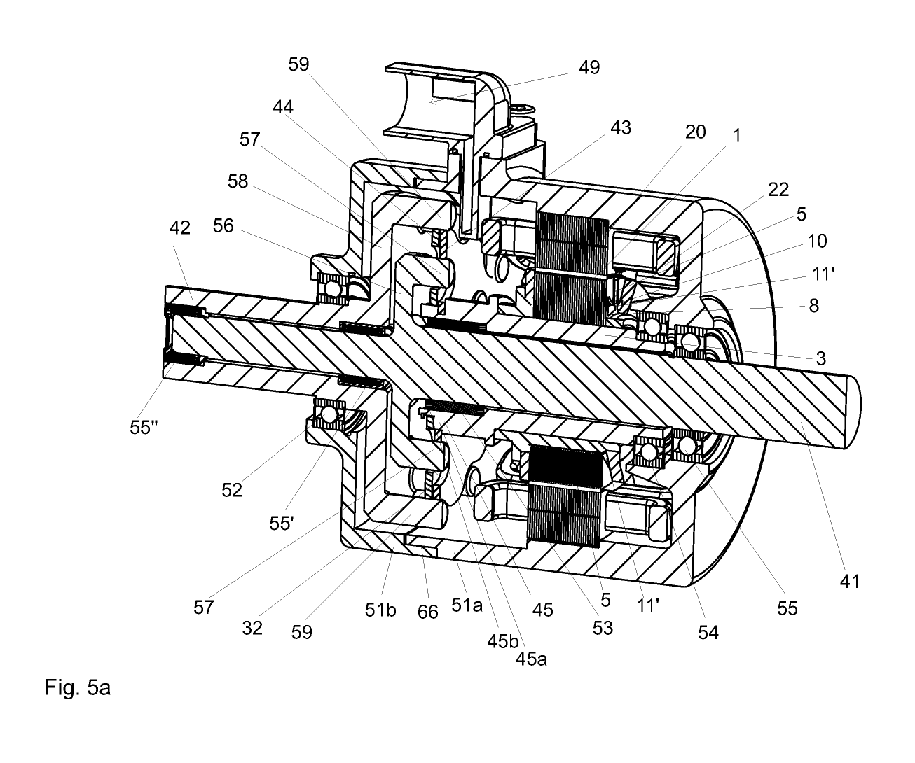

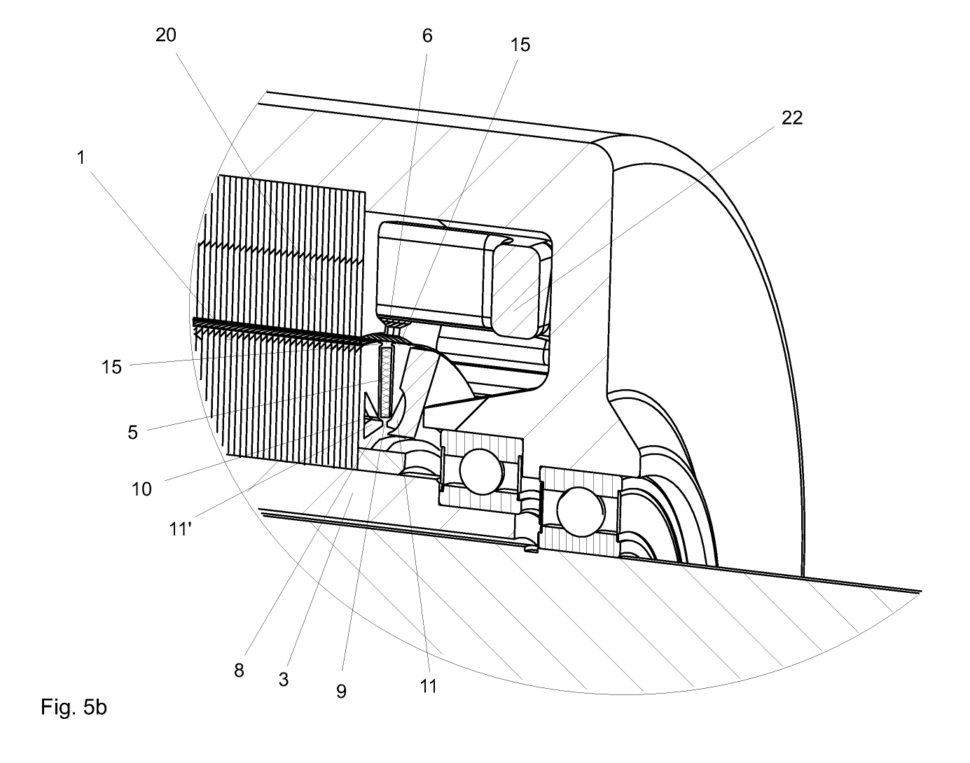

In the preferred embodiment the superposition device is located between steering wheel 120 and steering gearing 122, for example at the site denoted by 100. In FIGS. 5a, 5b to 11 a preferred embodiment of a superposition gearing 100 is shown in combined, compact disposition with the previously described electric motor and presented in greater detail.

In a further embodiment the superposition device is disposed between steering gearing 122 and tie rods 124 or in the steering gearing. The superposition device 127 in that case comprises a conversion gearing for the speed transformation of the rotational movement into a translational movement, for example a ball screw drive or a ball screw nut.

In all embodiments—in the normal case—the intention of the driver is fed through the steering wheel 120 via a sensor system, not shown here, as a signal 281 into a control apparatus 128. In the control apparatus 128 therefrom, potentially with the aid of a sensor signal of the booster drive of the steering system (signal line not shown here) and/or of the rotational number superposition unit and further signals describing the motor vehicle status, the corresponding control signals 282, 282′, 282″, often a control voltage, is determined for the electric motor and output to the electric motor, in the superposition device 100 or 100′ and/or the booster drive 100″ for the electrically assisted steering booster.

In conjunction with FIGS. 5a, 5b to 11 further details of the advantageous application of the electric motor according to the invention in a steering booster or a rotational number superposition device will be explained in further detail.

The superposition device 100 has an input shaft 41, which is driven directly or indirectly by the steering wheel 120, an output shaft 42, which directly or indirectly drives the tie rods, a carrier arrangement 51, an electric motor as a booster drive, and a disk cam gearing 43, 44, 45, 56, 57, 58, 59, which is disposed between the electric motor and the output shaft.

The rotational number superposition device, as depicted in FIGS. 5a and 5b comprises the following components:

a motor axis 2,

a driving device, here the input shaft 41, with the motor axis 2,

an output device, here the output shaft 42, with the motor axis 2,

a motor shaft 3 with the motor axis 2, which is connected with a rotor 1 of the electric motor according to the invention and is drivable by this electric motor,

a vehicle body-stationary carrier arrangement, implemented advantageously as a housing 51, such as, for example, comprised of the at least two housing parts 51a and 51 b, which support the shafts 41, 42 and the motor shaft 3 of the electric motor in bearings 52, 55, 55′, 55″ or 53, 54, wherein these housing parts can preferably be bolted together with a threading 66,

at least one disk cam 43, 44 disposed eccentrically rotatable about the motor axis 2 with a wave-like outer contour 33, 34, wherein the at least one disk cam 43, 44 has a circular coaxially disposed central opening 30a, 30b in the center and, wherein on a concentric reference circle of the cams, located between the central opening and the outer contour, at least two bores 31 are provided,

a first carrier 56 disposed torsion-tight on the input shaft 41, whose axis is located in the motor axis 2 and is rotatable about this axis, wherein on the first carrier 56, in the parallel direction to the motor axis 2, actuator bolts 57 are disposed which engage into the bores 31 of the disk cam 43, 44 and roll out or slide out on the inner faces 32, 32′,

a second carrier 58 disposed on a second shaft 42, which is implemented as an output shaft 42 and whose axis is located in the motor axis 2 and is rotatable about this axis, wherein on the second carrier 58, radially spaced apart in the parallel direction to the motor axis 2 on a reference circle concentric with respect to the motor axis, outer bolts 59 are disposed, on which the wave-shaped outer contour 33, 34 of the at least one disk cam 43, 44 rolls out through the eccentric radially gyratory movement;

wherein the motor shaft 3 is coaxially bearing supported such that it is rotatable about the input shaft 41 and the common motor axis 2 and is operationally connected with the rotor 1 and the motor shaft 3 for each disk cam bears an eccentric 45a, 45b associated with this cam as a connection gearing member with an eccentricity 62 with respect to the motor axis 2 and the eccentric engages into the central opening 30a, 30b of the associated disk cam 43, 44 in order to effect the laterally gyratory movement rotating about the motor axis 2 of the associated at least one disk cam 43, 44.

This superposition device 100 with the disk cam gearing can be employed alternatively for use for a rotational number superposition mechanism with advantage also as an electrically assisted steering booster, thus as driving device 100″. In this case the first shaft or input shaft 41 is connected torsion-tight with the housing 51a, 51b. As a rotational number superposition device the arrangement is especially suitable.

As an equivalent for the rotary transmission between the input shaft 41 and the laterally gyratorily moving disk cam 43, 44 by means of the bores 31 and the actuator bolts 57, the rotary transmission can also take place via an Oldham coupling or another coupling compensating eccentricities.

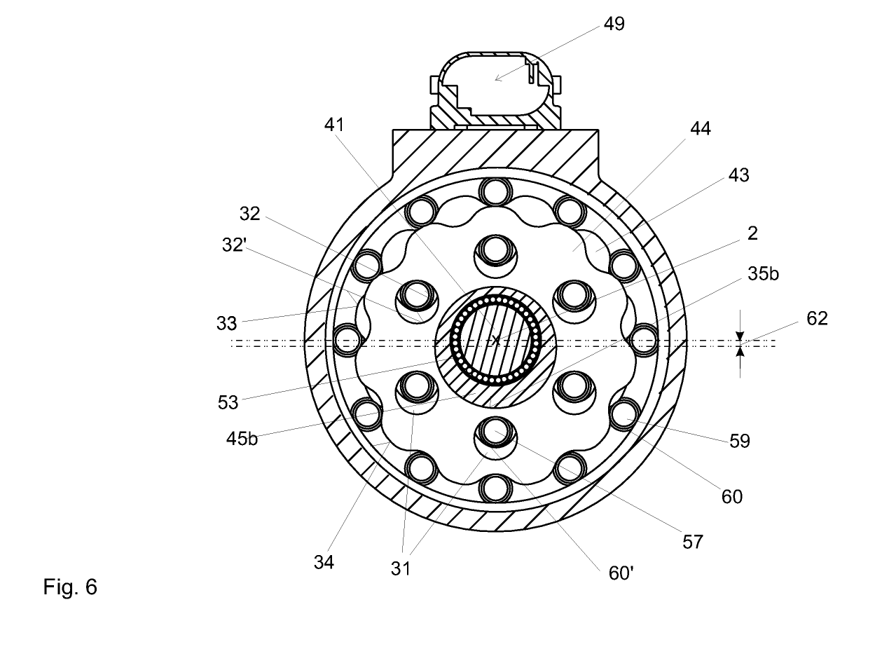

The disk cam gearing can be implemented with a single disk cam 43, 44, however, also with several disk cams 43, 44. The embodiment with two disk cams, such as is shown in FIGS. 5, 5a and 6, is preferred since herein a sufficiently large reduction of the running noise even at a still simpler realization can be attained.

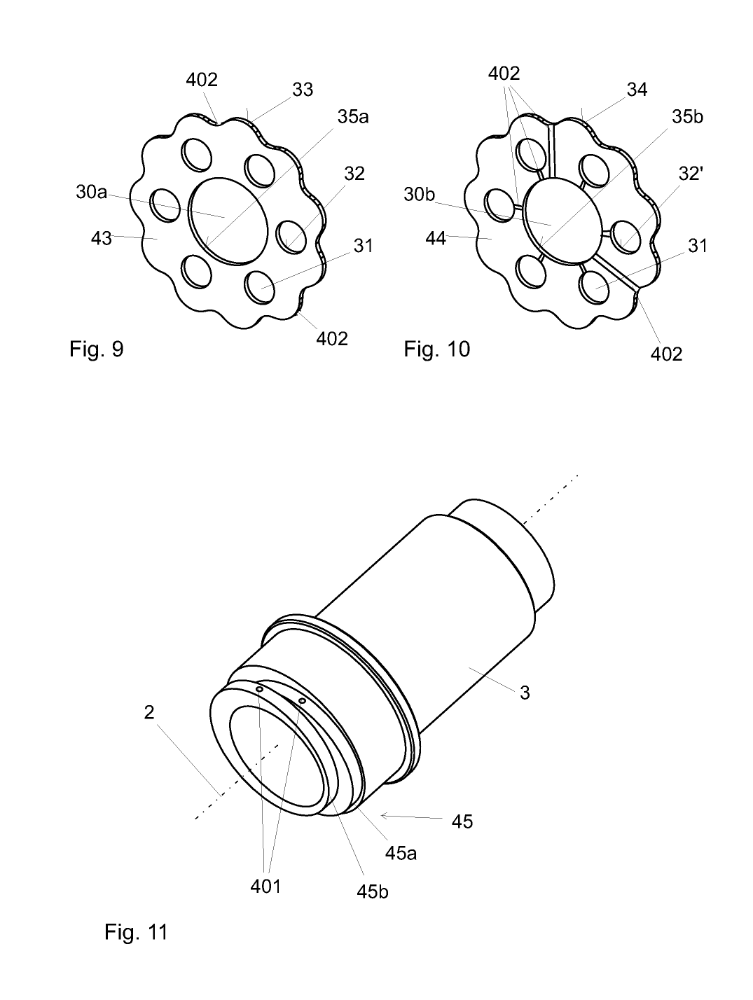

A first disk cam 43 is depicted in FIG. 9 in slightly oblique view. The circular disk cam 43 has a wave-like outer contour 33, on the faces of which the outer bolts 59 slide out through the eccentric and rotating movement. The wave-like outer contour 33 is formed as a circularly closed curve train with periodically repeating elevations and depressions, which have preferably a continuous, better yet a continuously differentiable, curve. The curve train is accordingly implemented such that it is circumferentially closed. The chosen number of wave periods is preferably in the range of 6 to 64 periods, an even number being preferred. To attain a uniform movement sequence, the outer contour can at least be partially formed in cycloid form.

In the center of the disk cam 43 coaxially with the disk center is formed a central opening 30a, into which an associated eccentric 45a, disposed on the rotor shaft 3, engages in order to generate the lateral gyratory movement by sliding out or rolling on the side face 35a of the central opening 30a. In addition, on a coaxial reference circle between the central opening 30a and the outer face 33 at least two bores 31 are provided in the disk cam 33. In FIGS. 9 and 10 six bores 31 are shown in order to attain uniform division of the forces. The bores 31 are uniformly distributed over the reference circle circumference. The number of bores if preferably in the range of 4 to 24. The bores 31 are greater in diameter about the eccentricity 22 of eccentric 45a than the diameter of the actuator bolts 57. The actuator bolts 57 engage into these bores 31 and slide out on their slide faces 32. It becomes thereby possible, on the one hand, to rotate the disk cam 43 about the motor axis and to allow it to gyrate laterally. When using more than one disk cam, these are entirely identical in their implementation. As an illustration, a second, identically formed disk cam 44 is shown again in FIG. 10 from the back side with the central opening 30b with its slide face 35b, the outer contour 34 and its bores 31 with their slide faces 32′. For secondary functions, such as for example lubrication, in the disk cams grooves 402 can be provided, wherein these grooves do not need to be introduced in all disk cams utilized.

FIG. 11 shows the rotor shaft 3 in three-dimensional view with the eccentrics 45. The example shows the preferred embodiment with two eccentrics 45a, 45b disposed thereon, which engage into the central openings 30a, 30b of two disk cams 43, 44. The eccentrics 45a, 45b are here disposed offset by 180°. When utilizing three disk cams with three eccentrics, these are offset by 120°. The offset angle is thus divided over 360° according to the number of disk cams.

The shape of the eccentric 45, the eccentricity 62, the shape of the outer contour 33 and their periodic number and the outer bolts, as well as the implementation of the bores with the actuator bolts are carefully matched to one another in order to attain the desired quiet and smooth synchronism at the appropriately predetermined transmission ratio. To simplify the mounting of the disk cams 43, 44, the individual eccentrics 45a, 45b can be implemented such that they are mountable as separate parts on the rotor shaft 3.

A first carrier arrangement for receiving the actuator bolts 57 is depicted in FIG. 8. The input shaft 41 or the holding shaft 41′ disposed in the motor axis 2, is connected torsion-tight with a disk-shaped first carrier 56. On this carrier 56 are disposed actuator bolts 57 at a radial spacing from the input shaft and uniformly distributed on a circle. These actuator bolts are oriented parallel to the motor axis 2 and in the assembled state engage into the bores 31 of the disk cams. In the presence of several disk cams 43, 44 each actuator bolt 57 extends through the successively disposed bores 31 of the several cams.

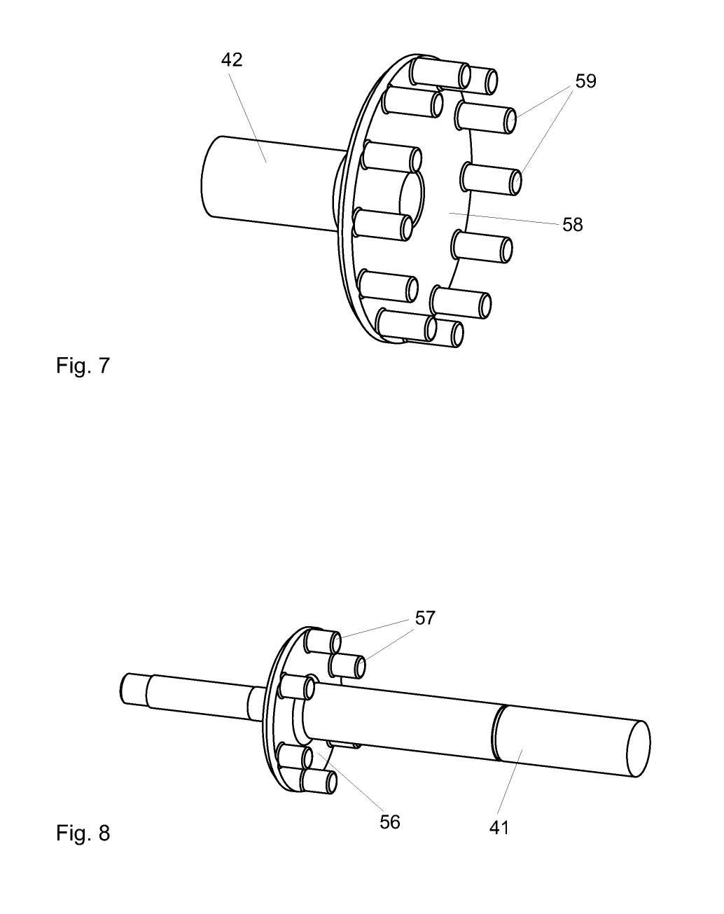

The second carrier arrangement for receiving the outer bolts 59 is depicted in FIG. 7. The output shaft 42 disposed in the motor axis 2 is connected torsion-tight with a disk-shaped second carrier 58. On this carrier 58 are disposed outer bolts 59 radially spaced apart from the input shaft and uniformly distributed on a circle. These bolts are oriented parallel to the motor axis 2 and extend over the outer contour 33 of the disk cam. In the presence of several disk cams 43, 44, each outer bolt 59 extends over the successively disposed outer contours 33, 34 of the disk cams 43, 44. In this case the wave trains of the outer contours 33, 34 are offset with respect to one another within the scope of the moving eccentricity, however, they are always in contact on and slide out on the outer bolts 59, such that these outer bolts 59, and thus the output shaft, is driven at a correspondingly stepped-down rotational number.

The outer bolts 59 and/or the actuator bolts 57 can be formed as friction bearing part or also, and preferably, include roller bearings. The eccentric(s) can also, or preferably, be provided with a roller bearing. However, for reasons of limited installation space, it may also be required, to provide only frictional contacts without special bearings.

The preferred implementation of a disk cam gearing with two disk cams 43, 44 is shown in cross section in FIG. 6. The first shaft, the input shaft 41 with the rotational axis 2 located in the center, is disposed on the chassis-stationary carrier arrangement 51 and supported rotatably about this axis. Coaxially over the input shaft 41 is located a bearing 53 for the rotationally movable bearing of the rotor shaft 3. On this rotor shaft 2, preferably at one end of the rotor shaft piece, two eccentrics 45a, 45b are disposed. In FIG. 6 in this cross sectional representation is evident the second eccentric 45b, which engages into the central opening 30a, 30b of the associated second disk cam 44 and here slides out or rolls out on its inner face 35a, 35b. The first eccentric 45a with the first disk cam 43 is located directly behind the second eccentric 45b and is therefore not visible in FIG. 6. The two eccentrics 45a, 45b are fixedly disposed on the rotor shaft 3 offset by 180° in the direction of rotation. The eccentrics 45a, 45b are preferably formed as circular disks disposed eccentrically at the eccentricity 62. The two disk cams 3, 4 with the associated outer contours 33, 34 and the circularly disposed bores 31 between the central openings and the outer contours are located laterally of the central axis 2 offset by the eccentricity corresponding to the position of the two eccentrics 45a, 45b. The actuator bolts 57 extend through the bores 31 in the disk cams and during rotation about the motor axis 2, and/or through the eccentric movement of the disk cams 43, 44, slide out on the inner faces 32, 32′ of the bores 31. An actuator bolt 57 thus extends through a bore 31 of the first disk cam 43 and simultaneously through a bore 57 of the second disk cam 44 located behind the first. The bores 31 are greater by the eccentricity 62 than the diameter of the actuator bolts 57 in order to ensure the continuous eccentric running and offset of the disk cams 43, 44. On the actuator bolts are preferably provided rolling bolt bearings 32, 32′, which upon the eccentric movement roll out on the slide faces 32, 32′ of the bores in order to decrease further the frictional forces.

Through the eccentric movement of the disk cams 43, 44 the wave trains of the outer contours 33, 34 of the two disk cams 43, 44 slide or roll out on the output bolts 59 disposed in the form of a wreath about these disk cams. The outer bolts 59 are uniformly distributed on a reference circle about the rotational center axis 2 on the second carrier 58 which carrier is connected torsion-tight with the output shaft 42. The radial spacing of the outer bolts 59 from the rotational axis 2, or the reference circle diameter, is selected such that the outer contours 33, 34 of the disk cams 43, 44 with the eccentric rotational movement are always in contact on the bolts 57. The bolts 57 can here also be implemented as friction bearing or preferably be provided with roller bearings 60, 60′. The number of periods, thus the elevations with the depressions, of the wave train of the outer contour 33, 34 of the disk cams 43, 44 is always one less than the number of outer bolts 59. In the example introduced in FIG. 6 the wave train of the two disk cams has eleven periods, wherein on the second carrier 58 twelve outer bolts 59 are disposed. The number of periods of the outer contour 33, 34 of the disk cam 43, 44 determines the transmission ratio of the disk cam gearing. In the example depicted here, the rotor shaft 3 with the eccentrics 45a, 45b must be rotated eleven times in order to attain one revolution at the output shaft 42. The transmission ratio for this case is consequently 1:11. For the application of the introduced disk cam gearing in a motor vehicle steering arrangement transmission ratios in the range of 1:11 to 1:64 are advantageously provided.

A further preferred embodiment of the rotational number superposition device comprises additionally a safety coupling or a latching device. In the event of a failure, for example during power failure or malfunction of the control apparatus, with the aid of the safety coupling a direct mechanical connection between steering wheel 120 and the tie rods to be swivelled is ensured. An electric motor with the implementation of the rotor 1 according to the invention, makes possible the realization of extremely compact driving systems with high efficience and great reliability at economic production. The combination with said steering boosters and/or rotational number superposition devices fulfills especially well the high requirements made here, since the correspondingly implemented electric motor according to the invention is specifically matched to the requirements important here.

What is claimed is:

1. Electric motor with an internally disposed rotor (1) with rotor poles (4) and with permanent magnets (5) and with an externally disposed stator (20) with stator poles (21) and stator windings (22) disposed thereon, wherein the rotor (1) and the stator (20) encompass the same centrally located motor axis (2) and the rotor (1) in cross section is implemented as a rotor ring (12) of ferromagnetic material with several cutouts (7) disposed thereon for magnets (5) spaced apart and circularly distributed and in which permanent magnets (5) are disposed whereby the rotor ring (12) is divided into rotor poles (4), each located between two permanent magnets (5), wherein the permanent magnets (5) are formed rectangularly in cross section with width (b) and height (h), and height (h) forms the longer side oriented in the radial direction away from the motor axis (2) and the permanent magnets (5) are magnetized in the direction of their width (b) and disposed in the rotor ring (12) such that the formed magnetic poles (N, S) of two adjacent permanent magnets (5) are oriented with like poles toward one another, characterized in that for each inner portion of a rotor pole (4) located between two adjacent permanent magnets (5) and oriented toward the motor axis (2) of the end region of the permanent magnets (5) a magnetic clearance (11, 11′) is formed and this clearance does not contain any magnetic material, such that in the particular center region of the rotor poles (4) in the radial direction for each rotor pole (4) one support web (10) is implemented, which web connects an inner support ring (8) with the particular rotor pole (4) providing mechanical support.

2. Electric motor as claimed in claim 1, characterized in that the support web (10) has a width in the range of 5% to 50% of the spacing of the ends, located toward the motor axis (2), of two adjacent permanent magnets (5).

3. Electric motor as claimed in claim 1, characterized in that the support web (10) has an expansion in the radial direction of at least 10% and maximally of 50% of the height (h) of a permanent magnet (5).

4. Electric motor as claimed in claim 1, characterized in that the magnetic clearance (11, 11′) is substantially triangular in cross section.

5. Electric motor as claimed in claim 1, characterized in that the rotor ring (12) with the rotor poles (4), the support webs (10), the support ring (8) with the cutouts (7) for the magnets (5) and the magnetic clearances (11, 11′) without magnetic material forms in cross section a single contiguous part of magnetic material and preferably is fabricated of punched iron sheet metal and several such iron metal sheets are stacked in the axial direction toward the motor axis.

6. Electric motor as claimed in claim 1, characterized in that the support web (10) with the magnetic clearances (11, 11′) formed on both sides thereon is geometrically implemented such that the magnetic material of the support web (10) is saturated by the field of the permanent magnets (5).

7. Electric motor as claimed in claim 1, characterized in that magnet stayings (9) are provided, which are delimited by the cutouts (7) and extend from the permanent magnet (5) to the support ring (8).

8. Electric motor as claimed in claim 1, characterized in that the stator poles (21) and the rotor poles (4) with their implementations, the cutouts (7) and clearances (11, 11′), are cut from one metal sheet, preferably from an iron metal sheet, and several are stacked in each case to form a stator pack and a rotor pack, wherein one stator metal sheet and one rotor metal sheet are punched simultaneously out of a single sheet metal piece.

9. Electric motor as claimed in claim 1, characterized in that the magnetic clearance (11, 11′) contains a nonmagnetic material, preferably a synthetic material.

10. Motor vehicle steering mechanism with an electric booster drive for an electrically assisted steering booster for the torque assistance (100″) and/or for the rotational angle superposition 100, 100′), characterized in that the booster drive includes an electric motor as claimed in claim 1.

11. Method for the production of an electric motor with an internally disposed rotor (1) with rotor poles (4) and with permanent magnets (5) and with an externally disposed stator (20) with stator poles (21) and stator windings (22) disposed thereon, wherein the rotor (1) and the stator (20) encompass the same centrally located motor axis (2) and the rotor (1) in cross section is implemented as a rotor ring (12) of ferromagnetic material with several cutouts (7) disposed thereon for magnets (5) which are spaced apart and circularly distributed and in which permanent magnets (5) are disposed whereby the rotor ring (12) is divided into rotor poles (4), each located between two permanent magnets (5), wherein the permanent magnets (5) are formed rectangularly in cross section with width (b) and height (h) and height (h) forms the longer side oriented in the radial direction away from the motor axis (2) and the permanent magnets (5) are magnetized in the direction of their width (b) and disposed in the rotor ring (12) such that the formed magnetic poles (N, S) of two adjacent permanent magnets (5) are oriented with like poles repellingly toward one another, characterized in that for each inner portion of a rotor pole (4) located between two adjacent permanent magnets (5), oriented toward the motor axis (2), of the end region of the permanent magnets (5) a magnetic clearance (11, 11′) is formed and this clearance does not contain any magnetic material, such that in the particular center region of the rotor poles (4) in the radial direction for each rotor pole (4) one support web (10) is implemented, which connects an inner support ring (8) with the particular rotor pole (4) providing mechanical support.
